(19) United States
(12) Patent Application Publication
(10) Pub. No.: US 2011/0069607 A1
(43) Pub. Date: Mar. 24, 2011

(54) METHODS AND SYSTEMS FOR CONTINUITY CHECK OF ETHERNET MULTICAST

(76) Inventor: Feng Huang, Shanghai (CN)

(21) Appl. No.: 12/735,398

(22) PCT Filed: Jan. 14, 2008
(86) PCT No.: PCT/CN2008/000090

§ 371 Date: Jul. 13, 2010

(51) Int. Cl. H04L 12/26

(52) U.S. Cl. 370/217; 370/216

(57) ABSTRACT

Methods and systems for continuity check of Ethernet multicast are provided. A root MEP multicasts frames with continuity check function information to all leaf MEPs in a multicast group, using a multicast DA. The leaf MEP in a defect condition transmits a frame with defect indication information to the root MEP. Responsive to receiving the frame with defect indication information, the root MEP, using a unicast address of the leaf MEP in a defect condition, transmits a frame with continuity loss information only to the leaf MEP in a defect condition.

### BACKGROUND OF THE INVENTION

1. Field of the Invention

The present invention general relates to a multicast Ethernet OAM (Operating Administration and Maintenance) mechanism, and more particularly to a method and system for continuity check of Ethernet multicast.

2. Description of the Related Art

With the rapidly expanding deployment of Ethernet, there is an increasing demand for Ethernet OAM functionality. Various standards are being developed that aim to provide advanced OAM capabilities (also referred to as Ethernet Connectivity and Fault Management or Ethernet CFM). In particular, two standards, IEEE 802. 1ag and ITU-T Y.1731, incorporated by reference herein, have defined the mechanism for OAM functionality in Ethernet networks, especially point-to-point (i.e. unicast) Ethernet OAM. In the context of ITU-T.Y.1731, an end point of an Ethernet MEG (Maintenance Entity Group) is called a “MEG End Point” or MEP. The MEP are used by system administrators to initiate and monitor OAM activity (by issuing appropriate OAM frames).

Ethernet continuity check function is used for proactive OAM. It is used to detect loss of continuity (LOC) between any pair of MEPs in a MEG and other defect conditions, such as mismerge, unexpected MEP, unexpected MEG Level, unexpected period, etc. The process of continuity check for a point-to-point connection is shown in FIG. 1. In the process, a CCM (Continuity Check Message) with RDI (Remote defect indication) bit being 0, is sent periodically from one MEP (e.g. MEP 101 in FIG. 1) to another MEP (e.g. MEP 102 in FIG. 1), step 110. If the link between the two MEPs is suffered, for example by SF (signal fail) or SD (signal degradation), MEP 102 will send back RDI to MEP 101, to indicate a fault for receiving the CCM, step 120. When MEP 101 received RDI, it enters into RDI defect status, and sends CCM with RDI bit being 1 to MEP 102, to indicate that there is something wrong on the link between them, step 130.

CCM and RDI are the most important elements to check and monitor the continuity. The format of CCM message used by a MEP is shown in FIG. 2. “MEL” (MEG Level) is used to identify MEG Level of OAM PDU. “Version” is used to identify the OAM protocol version which is always 0. “OpCode” is used to identify the type of the remaining content, and the value of OpCode for CCM is 1. “Flag” is used for RDI and other information needed by CCM in continuity check. “TLV Offset” contains the offset to the first TLV in an OAM PDU relative to the TLV Offset field and is set to 70 for CCM. “Sequence Number” is set to all-ZEROes for this Recommendation. “MEP ID” is used to identify the MEP transmitting the CCM frame and is unique within the MEG. “MEG ID” is used to identify the MEG to which the MEP transmitting the CCM frame belongs. Each of “TxFCf”, “TxFCb”, “RxFCb” is 4-octet integer values with samples of the wrap-around frame counters. “Reserved” fields are set to all-ZEROes. “End TLV” is an all-ZEROes octet value.

As a format of the field “Flag” shown in FIG. 3, RDI is indicated by the first bit of the field “Flag”. If the bit is 1, it indicates there is something wrong on the link, otherwise it is 0. “Period” contains the value of the CCM transmission period configured at the MEP 101 transmitting the CCM frame. The value of the field “Period” can be “000”, which means the CCM message is not transmitted periodically.

In the unicast scenario, the continuity check can be implemented in a relatively straightforward manner, through the continuity check process for a point-to-point connection described above. However, problems will occur in the multicast scenario, i.e. point-to-multipoint. In the multicast scenario, when the root MEP receive the RDI from a MEP in a defect condition which belongs to a multicast group, it will send all of the leaf MEPs in the multicast group a CCM message with RDI bit being 1. That will cause the system administrators to consider that all of the connections from root MEP to the leaf MEPs are down, and will in turn result in that all of the leaf MEPs consider that the connections between them and the root MEP are down, and then all of the leaf MEPs are disabled to transmit data through the connections. In other words, the problem is that the connections between the root MEP and the leaf MEPs which are not in a defect condition will be interrupted by the leaf MEP in a defect condition.

Now the commonly used solution for continuity check in multicast scenario is to use a group of a point-to-point continuity check, to verify the continuity of each connection between the root MEP and respective leaf MEP. In the continuity check process, the CCM is addressed to corresponding leaf MEP with the unicast DA (Destination MAC Address) of the leaf MEP. The unicast address of the unicast DA identifying the MEP uniquely in the multicast group doses not depend on the branching mechanism. Therefore, The continuity check mechanism is independent among all the leaf MEPs. It is a good method to check the continuity. However, the use of a point-to-point continuity check for each connection is inefficient and undermines the purpose of multicast in the first place—the goal of greater useable bandwidth and associated higher processing efficiency.

Thus, it would be an advancement in the art to provide methods and systems that allow for simpler and more efficient continuity check of Ethernet multicast, and that overcome the above limitations and disadvantages.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to methods and systems for continuity check of Ethernet multicast.

In an embodiment of the present invention, a method for continuity check of Ethernet multicast comprises multicasting frames with continuity check function information from a root MEP to all leaf MEPs in a multicast group, using a multicast DA; transmitting a frame with defect indication information from a leaf MEP in a defect condition to the root MEP; and responsive to receiving the frame with defect indication information, the root MEP, using a unicast address of the leaf MEP in a defect condition, transmitting a frame with continuity loss information only to the leaf MEP in a defect condition.

In another embodiment of the present invention, the method further comprises, upon receiving the frame with defect indication information, the root MEP removing the unicast address of the leaf MEP in a defect condition from the multicast DA.

In another embodiment of the present invention, the method further comprises, after removing the unicast address from the multicast DA, multicasting the frames with continuity check function information as before from the root MEP to all leaf MEPs in the multicast group except the leaf MEP in a defect condition, using the multicast DA.

In an embodiment of the present invention, a system for continuity check of Ethernet multicast, comprising a root MEP and a plurality of leaf MEPs in a multicast group. The root MEP comprises a transmitter, configured to multicast frames with continuity check function information to all of the plurality of leaf MEPs in the multicast group, using a multicast DA, and configured to transmit, responsive to receiving a frame with defect indication information from a leaf MEP in the multicast group, a frame with continuity loss information only to the leaf MEP, using the unicast address of the leaf MEP; and a receiver, configured to receive the frame with defect indication information from the leaf MEP in a defect condition. The leaf MEP comprises a transmitter configured to transmit a frame with defect indication information to the root MEP, upon detecting a defect condition; and a receiver configured to receive the frames with continuity check function information with the multicast DA and the frame with continuity loss information with its own unicast address, from the transmitter of the root MEP.

With the solution of the present invention, it is efficient to perform the continuity check through multicast. Furthermore, it is simple than the prior art in which a group of a point-to-point continuity check is utilized. At the same time, through the present invention, the connection between the root MEP and the leaf MEP in a defect condition will not interrupt the other connections between the other leaf MEPs that are not in a defect condition and the root MEP. Additionally, the compatibility with the existed OAM specifications can be preserved.

Those skilled in the art will appreciate that the above is merely an introduction to the subject matter described in more detail below.

### BRIEF DESCRIPTION OF THE DRAWINGS

The present invention may be better understood, and its numerous objects, features, and advantages made apparent to those skilled in the art by referring the accompanying drawings, wherein

FIG. 1 schematically illustrates a process of continuity check for a point-to-point connection in the prior art;

FIG. 2 illustrates a standardized format of CCM message;

FIG. 3 illustrates a standardized format of RDI;

FIG. 4 shows a schematic functional block of the system for continuity check of Ethernet multicast in accordance with an embodiment of the present invention;

FIG. 5 is a sequence diagram illustrating a method for continuity check of Ethernet multicast in accordance with an embodiment of the present invention; and

FIG. 6 is a flow chart illustrating a further method for continuity check of Ethernet multicast in accordance with another embodiment of the present invention.

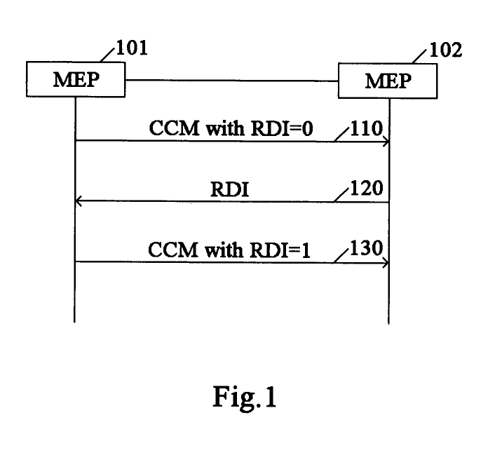

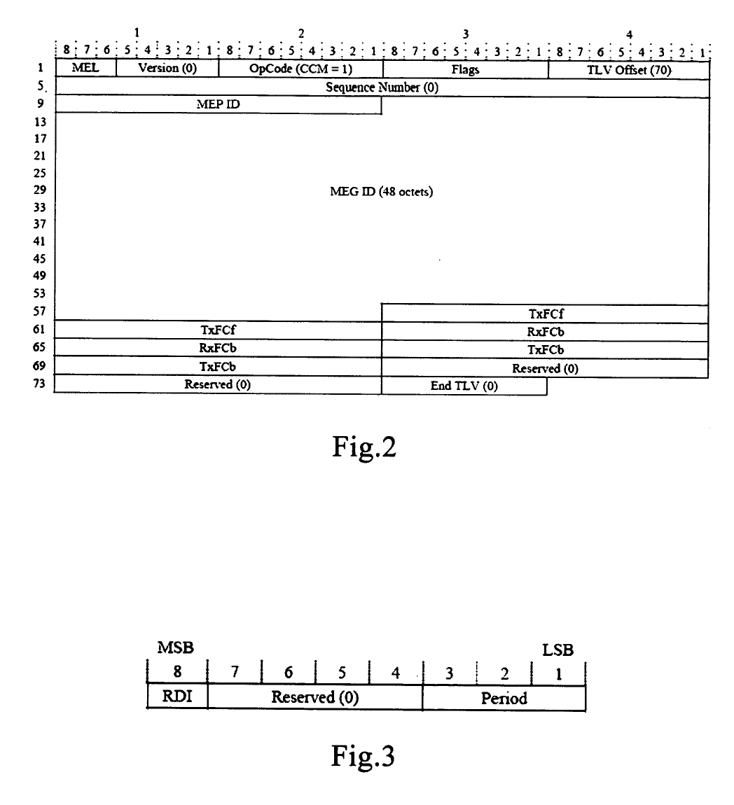

### DETAILED DESCRIPTION OF EXEMPLARY EMBODIMENTS

In the following description of the various illustrative embodiments, reference is made to the accompanying drawings, which form a part hereof, and in which are shown by way of illustration various exemplary embodiments in which the invention may be practiced. It is to be understood that other embodiments may be utilized and structural and functional modifications may be made without departing from the scope of the present invention.

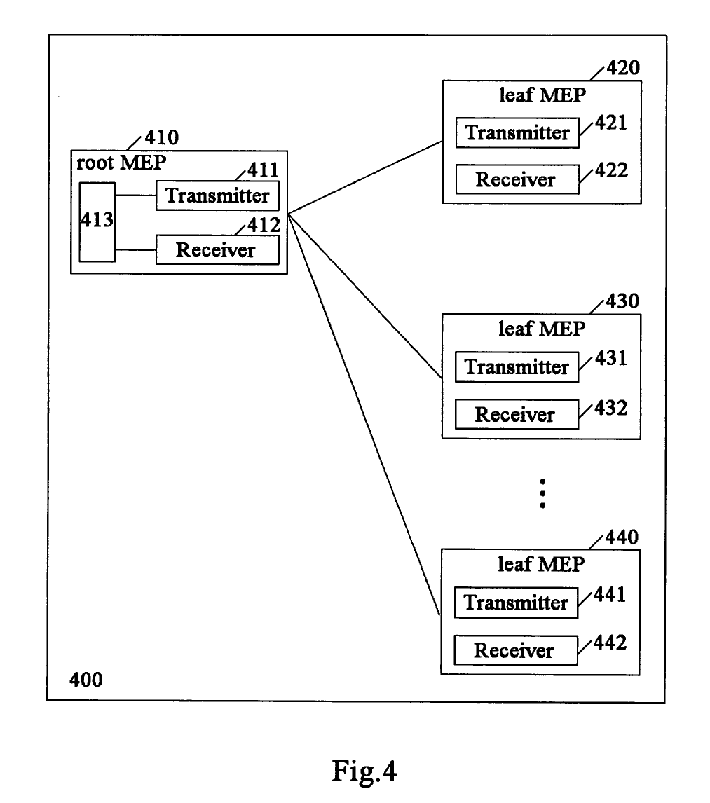

FIG. 4 shows a schematic functional block of an Ethernet multicast system in which the present invention can be implemented. The structure and functions of such an Ethernet multicast system and those of the associated network elements are only described when relevant to the invention.

The system 400, according to an exemplary embodiment, comprises a plurality of leaf MEPs 420, 430, and 440, and a root MEP 410. The root MEP 410 can multicast data to all of the leaf MEPs which belong to a MEP group, thereby advantageously saving bandwidth resources from the root to the leaf if more than two leaf MEPs are to be transmitted to.

The root MEP 410 comprises transmitter 411 and receiver 412, which are used for transmitting or receiving frames for the continuity check process to or from leaf MEPs 420, 430, and 440, respectively. The basic structure and operation of transmitter 411 and receiver 412 are known to one skilled in the art and only the details relevant to the present solution are discussed in detail. Root MEP 410 further comprises means 413, which is coupled to transmitter 411 and receiver 412 and used for managing the continuity check of Ethernet multicast. The functions of means 413 may be implemented with a digital signal processor, memory, and computer programs for executing computer processes.

Each of leaf MEPs 420, 430, 440, comprises transmitter 421, 431, 441 and receiver 422, 432, 442 respectively, which are used for transmitting or receiving frames for the continuity check process to or from root MEP 410. The basic structure and operation of transmitter 422, 432, 442 and receiver 422, 432, 442 are known to one skilled in the art and only the details relevant to the present solution are discussed in detail.

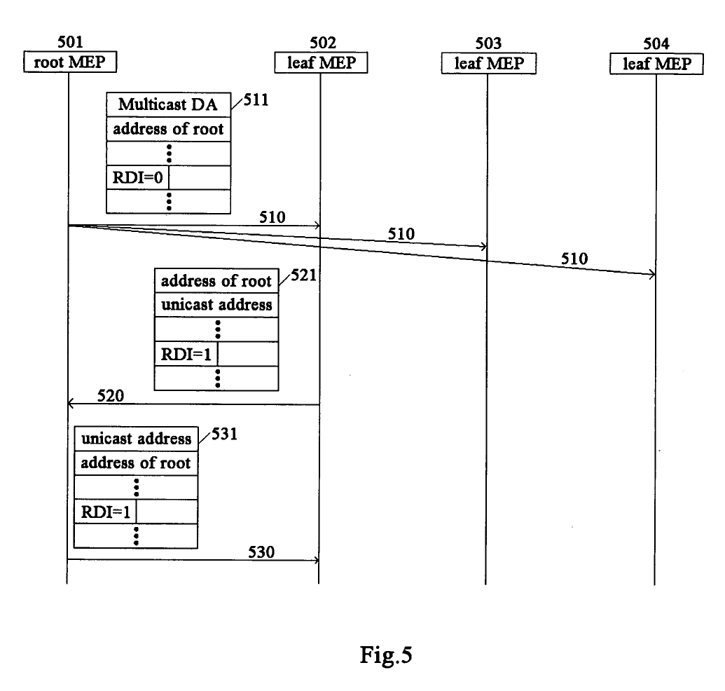

Now a description of the process of continuity check of Ethernet multicast in accordance with an embodiment of the present invention is made referred to FIG. 5. The process can be initiated by system administrator manually or automatically. The structures and functions of a root MEP 501, and leaf MEP 502, 503, 504, are the same to the corresponding elements (root MEP 410, and leaf MEP 420, 430, 440) in system 400 illustrated in FIG. 4.

In step 510, root MEP 501 multicasts frames with continuity check information, i.e. frames carrying CCM message which are called CCM frames, to all of the leaf MEPs 502, 503, 504 in a multicast group. Preferably, the CCM frames can be transmitted periodically and the period can be set in the related bits as described with reference to FIG. 3. The multicast mechanism is similar to the normal multicast in Ethernet network. The simplified format of the CCM frame is illustrated as block 511 above the arrows that denotes step 510, wherein the RDI bit is 0. The CCM frames 511 are addressed to all of the leaf MEPs with a multicast DA of the multicast group.

When leaf MEP 502 in the multicast group has encountered a defect condition, for example, leaf MEP 502 have not received the CCM frames 511 in 3.5 period, it will transmit a frame with defect indication information to root MEP 501, as shown in step 520. The frame is preferably a CCM frame, wherein the RDI bit is set to 1 by leaf MEP 502, to indicate that the continuity between leaf MEP 502 and root MEP 501 is a in defect condition. The simplified format of the CCM frame is illustrated as block 521 above the arrow that denotes step 520, wherein the unicast address of leaf MEP 502 is provided in the field “Source”.

In step 530, responsive to receiving the CCM frame with RDI=1 from leaf MEP 502, root MEP 501 will transmit a frame with continuity loss information to leaf MEP 502, to confirm the continuity between root MEP 501 and leaf MEP 502 has been lost. The frame is preferably a CCM frame, wherein the RDI bit is 1. The simplified format of the CCM frame is illustrated as block 531 above the arrow that denotes step 530. CCM frame 531 is addressed only to leaf MEP 502 with the unicast address of leaf MEP 502 and the other leaf MEPs 503, 504 would not receive CCM frame 531.

When leaf MEP 502 received CCM frame 531, it stop to receive and/or transmit data from/to root MEP 503. In some cases, leaf MEP 502 will start a protection mechanism according to a predefined specification or additional indication information carried in CCM frame 531.

As can be appreciated to one skilled in the art, root MEP 501 and leaf MEPs 502, 503, and 504 are illustrative, and the leaf MEP in a defect condition can be any of the leaf MEPs in the multicast group. The number of leaf MEPs in a defect condition is not limited to one, but any possible number.

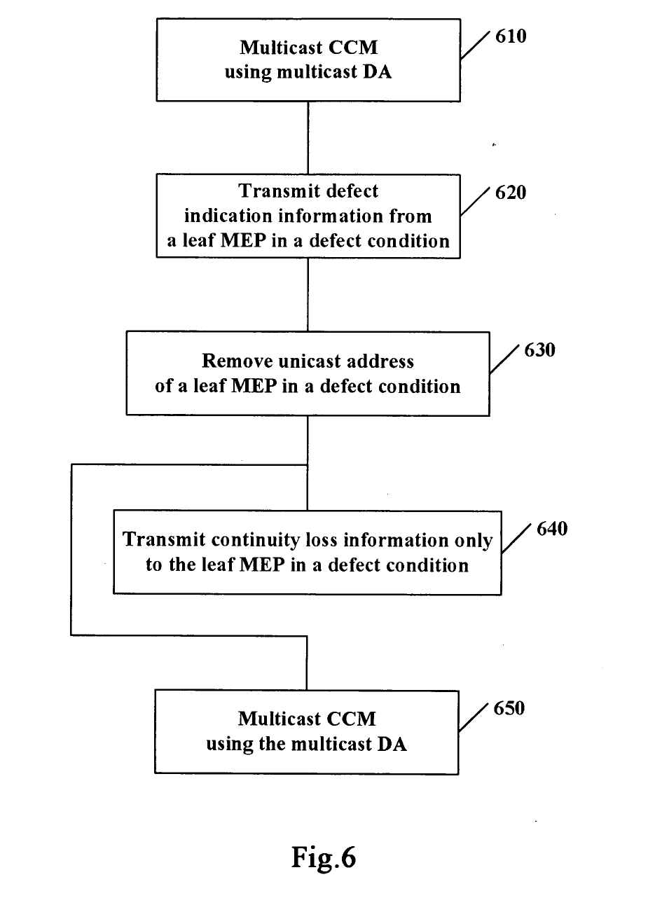

FIG. 6 is a flow chart illustrating a further method for continuity check of Ethernet multicast in accordance with another embodiment of the present invention. In the process shown in FIG. 6, the steps 610, 620 and 640 are similar to the corresponding steps 510-530 illustrated in FIG. 5. The difference lies in that, upon receiving the frame with defect indication information, root MEP 501 can remove the unicast address of leaf MEP 502 in a defect condition from the multicast DA. For example, means 413 in the root MEP can extract the unicast address and remove it from a list about the mapping between the unicast addresses of the leaf MEPs in the multicast group and the multicast DA. Preferably, the removing can be achieved through making the leaf MEP in a defect condition leave the multicast group. A more detailed description of the removing is provided in IETF RFC4604-IGMP (Internet Group Management Protocol), entitled “Using Internet Group Management Protocol Version 3 (IGMPv3) and Multicast Listener Discovery Protocol Version 2 (MLDv2) for Source-Specific Multicast,” and IEEE802.1d-2004—Chapter 10-GMRP(GARP multicast register protocol), entitled “Media Access Control (MAC) bridge”, which are incorporated herein by reference in its entirety.

The process can further comprises step 650, which is preformed after step 630. In step 650, after removing the unicast address from the multicast DA, root MEP 501 continue to multicast the frames with continuity check function information as before, i.e. as in step 610, to all leaf MEPs 503, 504 in the multicast group except leaf MEP 502, using the multicast DA. Since the unicast address has been removed from the multicast DA, the MEP 502 would not receive the frames multicasted using the multicast DA. Step 650 may or may not occur at the same time with step 640. Step 650 may occur before or after step 640, depending on the settings in root MEP 501.

One or more aspects of the invention may be embodied in computer-executable instructions, such as in one or more program modules, executed by one or more computers or other devices. Generally, program modules include routines, programs, objects, components, data structures, etc. that perform method steps of the invention when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Although the invention has been described with reference to specific embodiments, this description is not mean to be constructed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

1. A method for continuity check of Ethernet multicast, comprising the steps of:
multicasting frames with continuity check function information from a root Maintenance Entity Group End Point (MEP) to all leaf MEPs in a multicast group, using a multicast destination MAC address (DA);
transmitting a frame with defect indication information from a leaf MEP in a defect condition to the root MEP; and
responsive to receiving the frame with the defect indication information, the root MEP, using a unicast address of the leaf MEP in a defect condition, transmitting a frame with continuity loss information only to the leaf MEP in the defect condition.

2. The method of claim 1, further comprising the step of:
upon receiving the frame with the defect indication information, the root MEP removing the unicast address of the leaf MEP in the defect condition from the multicast DA.

3. The method of claim 2, wherein said removing the unicast address from the multicast DA is effectuated by making the leaf MEP in the defect condition leave the multicast group.

4. The method of claim 2, further comprising the step of:
after removing the unicast address from the multicast DA, multicasting the frames with the continuity check function information from the root MEP to all leaf MEPs in the multicast group except the leaf MEP in the defect condition, using the multicast DA.

5. The method of claim 1, wherein said multicasting is performed periodically.

6. A system for continuity check of Ethernet multicast, comprising a root Maintenance Entity Group End Point (MEP) and a plurality of leaf MEPs in a multicast group, wherein the root MEP comprises:
a transmitter, configured to multicast frames with continuity check function information to all of the plurality of leaf MEPs in the multicast group, using a multicast destination MAC address (DA), and configured to transmit, responsive to receiving a frame with defect indication information from a leaf MEP in the multicast group, a frame with continuity loss information only to the leaf MEP, using the unicast address of the leaf MEP; and
a receiver, configured to receive the frame with the defect indication information from the leaf MEP in a defect condition; and
the leaf MEP comprises:
a transmitter configured to transmit a frame with the defect indication information to the root MEP, upon detecting the defect condition; and
a receiver configured to receive the frames with the continuity check function information with the multicast DA and the frame with the continuity loss information with its own unicast address, from the transmitter of the root MEP.

7. The system of claim 6, wherein the root MEP further comprises:
means for removing a unicast address of a leaf MEP from the multicast DA, upon receive a frame with the defect indication information from the leaf MEP.

8. The system of claim 7, wherein the means for removing the unicast address from the multicast DA is configure to remove the unicast address from the multicast DA by making the leaf MEP leave the multicast group.

9. The system of claim 6, wherein the transmitter of the root MEP is further configured to,
after removing the unicast address from the multicast DA, multicast frames with the continuity check function information to all leaf MEPs in the multicast group except the leaf MEP from which the frame with the defect indication information is transmitted, by using the multicast DA.

10. The system of claim 6, wherein the transmitter of the root MEP is configured to multicast the frames with the continuity check function information periodically.
